(19) United States
(12) Patent Application Publication
(10) Pub. No.: US 2024/0034348 A1
(43) Pub. Date: Feb. 1, 2024

(54) LIVE REMOTE ASSISTANCE REQUEST AND RESPONSE SESSIONS

(71) Applicant: GM Cruise Holdings LLC, San Francisco, CA (US)

(72) Inventors: Andrew Robinson, San Francisco, CA (US); Jeremy Allan, Menlo Park, CA (US); Nishant Sharma, Hayward, CA (US)

(73) Assignee: GM Cruise Holdings LLC, San Francisco, CA (US)

(21) Appl. No.: 17/815,143

(22) Filed: Jul. 26, 2022

(51) Int. Cl. B60W 60/00; G08G 1/00

(52) U.S. Cl. CPC B60W 60/001; G08G 1/20; B60W 2420/52; B60W 2420/42

(57) ABSTRACT

A method is described and includes detecting by a vehicle an ambiguous situation involving the vehicle; classifying the detected ambiguous situation; and submitting in substantially real-time a request for remote assistance by a remote advisor to resolve the detected ambiguous situation, wherein contents of the request are based at least in part on the classifying.

### BACKGROUND

### Technical Field

The present disclosure relates generally to autonomous vehicles (AVs) and, more specifically, to techniques for implementing live remote assistance request and response sessions for such AVs.

### Introduction

An AV is a motorized vehicle that can navigate without a human driver. An exemplary AV can include various sensors, such as a camera sensor, a light detection and ranging (LIDAR) sensor, and a radio detection and ranging (RADAR) sensor, among others. The sensors collect data and measurements that the AV can use for operations such as navigation. The sensors can provide the data and measurements to an internal computing system of the AV, which can use the data and measurements to control a mechanical system of the AV, such as a vehicle propulsion system, a braking system, or a steering system. Typically, the sensors are mounted at fixed locations on the AVs.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 illustrates an example system environment that can be used to facilitate autonomous vehicle (AV) dispatch and operations, according to some aspects of the disclosed technology;

FIGS. 2-4 are flowcharts illustrating example operations of some aspects of the disclosed technology;

FIG. 5 illustrates an example of a deep learning neural network that can be used to implement a perception module and/or one or more validation modules, according to some aspects of the disclosed technology; and

FIG. 6 illustrates an example processor-based system with which some aspects of the disclosed technology can be implemented.

### DETAILED DESCRIPTION

### Overview

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

Given the numerous advantages of ride hail, rideshare, and delivery services (which services may be collectively and/or interchangeably referred to herein simply as rideshare services whether for a single user/passenger, multiple users/passengers, and/or one or more items for delivery) provided by AVs, it is anticipated that AV rideshare services will soon become the ubiquitous choice for various user transportation and delivery needs, including but not limited to school commutes, airport transfers, long distance road trips, and grocery and restaurant deliveries, to name a few.

In certain rideshare service systems, when an AV of a fleet of AVs encounters and/or otherwise detects a lane blockage or obstruction, the AV may report the lane blockage to a universal blockage map (which in certain embodiments may be a time-decaying map), which may be shared as part of geospatial data shared across the fleet of AVs and used to influence routing costs by causing other AVs in the fleet to avoid the blockage. In situations in which such a blockage is due to construction, for example, successful detection and mapping of the blockage can reduce mission failures by routing other AVs away from the blockage. In contrast, in situations in which the blockage is merely a temporary blockage (e.g., due to a double-parked vehicle (DPV) making a delivery, for example) or not a blockage at all (e.g., a misperception or misclassification of an object), routing other vehicles in the fleet away from the area for a longer period of time than necessary can negatively impact ride or delivery quality and unnecessarily increase ride or delivery time. As a result, it would be useful to avoid reporting false positives and/or incorrect blockage characterization with regard to ambiguous (as perceived by the AV) lane blockages.

Similarly, there are situations in which an AV may encounter a potential map change in which the real-world as perceived by the AV does not match the map data being used by the AV for routing and planning. For example, a traffic light expected by the AV to be encountered at an intersection may not be observed by the AV. In such situations, it would be useful to determine whether the traffic light has been moved to an area not expected by the AV and if so, to update the map data accordingly.

In accordance with features of embodiments described herein, techniques are provided for implementing a live remote assistance (RA) request and response (R&R) session for AVs. In certain embodiments, when an obstruction (e.g., a DPV or construction) in the road is detected or an expected object (e.g., a traffic light) is not detected or is detected in a different place than expected, with a confidence level of less than a predetermined threshold value, a planning stack (or any other stack) of the AV can request human assistance from a remote advisor. In certain examples, sensors of the AV may capture live sensor data of the environment of the vehicle, which live captured sensor data may include video, audio, light detection and ranging (LIDAR), radio detection and ranging (RADAR) and/or individual camera images, for example. The live captured sensor data may be provided to the remote advisor to enable the advisor to provide a real-time or near real-time response to the request. As used herein, real-time and near real-time correspond to a level of responsiveness within a service level agreement (SLA)-specified time constraint between a request and a response to the request.

Once a response to the request is received, the AV may take action based on the response. Additionally, map data provided to the AV fleet may be updated based on the response. For example, the fleet map data may be updated in cases in which the detected obstruction is determined to be an actual blockage or obstruction. In contrast, the fleet map data is only temporarily updated or not updated at all if the detected obstruction is determined to be only a temporary obstruction (e.g., a DPV) or not an obstruction at all (e.g., a mischaracterized object).

In other embodiments, the live remote assistance R&R session can assist in accurately confirming or denying map changes detected by the AV by reviewing images and/or other sensor data provided by the AV to the remote advisor for such purpose. As a result, the live remote assistance R&R sessions may operate to increase the integrity of map data used by the AV fleet to navigate around an area defined by the map.

The following detailed description presents various descriptions of specific certain embodiments. However, the innovations described herein can be embodied in a multitude of different ways, for example, as defined and covered by the claims and/or select examples. In the following description, reference is made to the drawings, in which like reference numerals can indicate identical or functionally similar elements. It will be understood that elements illustrated in the drawings are not necessarily drawn to scale. Moreover, it will be understood that certain embodiments can include more elements than illustrated in a drawing and/or a subset of the elements illustrated in a drawing. Further, some embodiments can incorporate any suitable combination of features from two or more drawings.

The following disclosure describes various illustrative embodiments and examples for implementing the features and functionality of the present disclosure. While particular components, arrangements, and/or features are described below in connection with various example embodiments, these are merely examples used to simplify the present disclosure and are not intended to be limiting. It will of course be appreciated that in the development of any actual embodiment, numerous implementation-specific decisions must be made to achieve the developer's specific goals, including compliance with system, business, and/or legal constraints, which may vary from one implementation to another. Moreover, it will be appreciated that, while such a development effort might be complex and time-consuming; it would nevertheless be a routine undertaking for those of ordinary skill in the art having the benefit of this disclosure.

In the drawings, a particular number and arrangement of structures and components are presented for illustrative purposes and any desired number or arrangement of such structures and components may be present in various embodiments. Further, the structures shown in the figures may take any suitable form or shape according to material properties, fabrication processes, and operating conditions. For convenience, if a collection of drawings designated with different letters are present (e.g., FIGS. 10A-10C), such a collection may be referred to herein without the letters (e.g., as FIG. 10). Similarly, if a collection of reference numerals designated with different letters are present (e.g., 110a-110e), such a collection may be referred to herein without the letters (e.g., as 110).

In the Specification, reference may be made to the spatial relationships between various components and to the spatial orientation of various aspects of components as depicted in the attached drawings. However, as will be recognized by those skilled in the art after a complete reading of the present disclosure, the devices, components, members, apparatuses, etc. described herein may be positioned in any desired orientation. Thus, the use of terms such as above, below, upper, lower, top, bottom, or other similar terms to describe a spatial relationship between various components or to describe the spatial orientation of aspects of such components, should be understood to describe a relative relationship between the components or a spatial orientation of aspects of such components, respectively, as the components described herein may be oriented in any desired direction. When used to describe a range of dimensions or other characteristics (e.g., time, pressure, temperature, length, width, etc.) of an element, operations, and/or conditions, the phrase between X and Y represents a range that includes X and Y. The terms substantially, close, approximately, near, and about, generally refer to being within +/−20% of a target value (e.g., within +/−5 or 10% of a target value) based on the context of a particular value as described herein or as known in the art.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

Other features and advantages of the disclosure will be apparent from the following description and the claims.

Example AV Management System

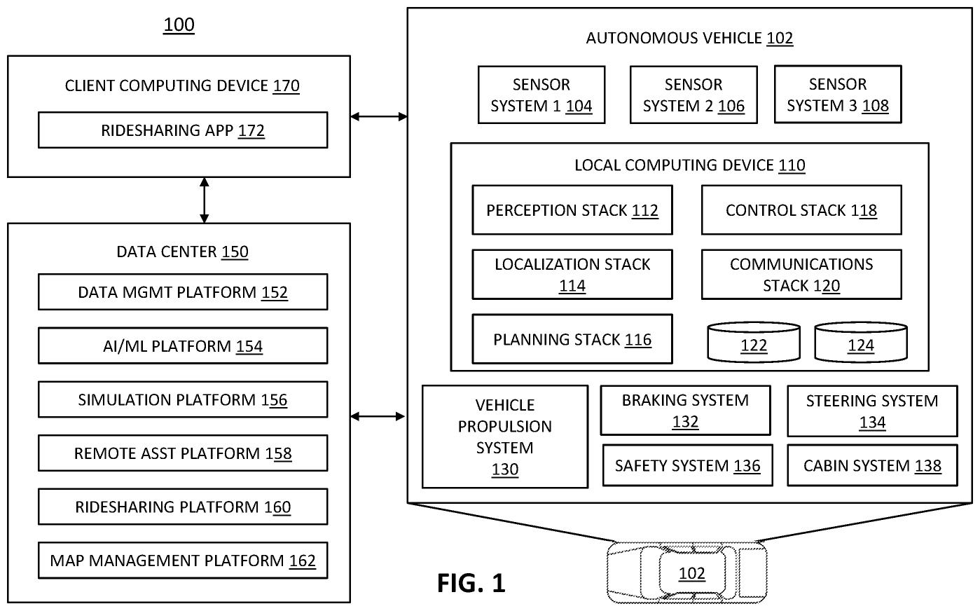

FIG. 1 illustrates an example of an AV management system 100. One of ordinary skill in the art will understand that, for the AV management system 100 and any system discussed in the present disclosure, there can be additional or fewer components in similar or alternative configurations. The illustrations and examples provided in the present disclosure are for conciseness and clarity. Other embodiments may include different numbers and/or types of elements, but one of ordinary skill the art will appreciate that such variations do not depart from the scope of the present disclosure.

In this example, the AV management system 100 includes an AV 102, a data center 150, and a client computing device 170. The AV 102, the data center 150, and the client computing device 170 can communicate with one another over one or more networks (not shown), such as a public network (e.g., the Internet, an Infrastructure as a Service (IaaS) network, a Platform as a Service (PaaS) network, a Software as a Service (SaaS) network, another Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

AV 102 can navigate about roadways without a human driver based on sensor signals generated by multiple sensor systems 104, 106, and 108. The sensor systems 104-108 can include different types of sensors and can be arranged about the AV 102. For instance, the sensor systems 104-108 can comprise Inertial Measurement Units (IMUS), cameras (e.g., still image cameras, video cameras, etc.), light sensors (e.g., LIDAR systems, ambient light sensors, infrared sensors, etc.), RADAR systems, a Global Navigation Satellite System (GNSS) receiver, (e.g., Global Positioning System (GPS) receivers), audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 104 can be a camera system, the sensor system 106 can be a LIDAR system, and the sensor system 108 can be a RADAR system. Other embodiments may include any other number and type of sensors.

AV 102 can also include several mechanical systems that can be used to maneuver or operate AV 102. For instance, the mechanical systems can include vehicle propulsion system 130, braking system 132, steering system 134, safety system 136, and cabin system 138, among other systems. Vehicle propulsion system 130 can include an electric motor, an internal combustion engine, or both. The braking system 132 can include an engine brake, a wheel braking system (e.g., a disc braking system that utilizes brake pads), hydraulics, actuators, and/or any other suitable componentry configured to assist in decelerating AV 102. The steering system 134 can include suitable componentry configured to control the direction of movement of the AV 102 during navigation. Safety system 136 can include lights and signal indicators, a parking brake, airbags, and so forth. The cabin system 138 can include cabin temperature control systems, in-cabin entertainment systems, and so forth. In some embodiments, the AV 102 may not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUIs), etc.) for controlling certain aspects of the mechanical systems 130-138.

AV 102 can additionally include a local computing device 110 that is in communication with the sensor systems 104-108, the mechanical systems 130-138, the data center 150, and the client computing device 170, among other systems. The local computing device 110 can include one or more processors and memory, including instructions that can be executed by the one or more processors. The instructions can make up one or more software stacks or components responsible for controlling the AV 102; communicating with the data center 150, the client computing device 170, and other systems; receiving inputs from riders, passengers, and other entities within the AV's environment; logging metrics collected by the sensor systems 104-108; and so forth. In this example, the local computing device 110 includes a perception stack 112, a mapping and localization stack 114, a planning stack 116, a control stack 118, a communications stack 120, a High Definition (HD) geospatial database 122, and an AV operational database 124, among other stacks and systems.

Perception stack 112 can enable the AV 102 to see (e.g., via cameras, LIDAR sensors, infrared sensors, etc.), hear (e.g., via microphones, ultrasonic sensors, RADAR, etc.), and feel (e.g., pressure sensors, force sensors, impact sensors, etc.) its environment using information from the sensor systems 104-108, the mapping and localization stack 114, the HD geospatial database 122, other components of the AV, and other data sources (e.g., the data center 150, the client computing device 170, third-party data sources, etc.). The perception stack 112 can detect and classify objects and determine their current and predicted locations, speeds, directions, and the like. In addition, the perception stack 112 can determine the free space around the AV 102 (e.g., to maintain a safe distance from other objects, change lanes, park the AV, etc.). The perception stack 112 can also identify environmental uncertainties, such as where to look for moving objects, flag areas that may be obscured or blocked from view, and so forth.

Mapping and localization stack 114 can determine the AV's position and orientation (pose) using different methods from multiple systems (e.g., GPS, IMUs, cameras, LIDAR, RADAR, ultrasonic sensors, the HD geospatial database 122, etc.). For example, in some embodiments, the AV 102 can compare sensor data captured in real-time by the sensor systems 104-108 to data in the HD geospatial database 122 to determine its precise (e.g., accurate to the order of a few centimeters or less) position and orientation. The AV 102 can focus its search based on sensor data from one or more first sensor systems (e.g., GPS) by matching sensor data from one or more second sensor systems (e.g., LIDAR). If the mapping and localization information from one system is unavailable, the AV 102 can use mapping and localization information from a redundant system and/or from remote data sources.

The planning stack 116 can determine how to maneuver or operate the AV 102 safely and efficiently in its environment. For example, the planning stack 116 can receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., an Emergency Vehicle (EMV) blaring a siren, intersections, occluded areas, street closures for construction or street repairs, DPVs, etc.), traffic rules and other safety standards or practices for the road, user input, and other relevant data for directing the AV 102 from one point to another. The planning stack 116 can determine multiple sets of one or more mechanical operations that the AV 102 can perform (e.g., go straight at a specified speed or rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 116 can select from multiple backup plans to carry out. For example, while preparing to change lanes to turn right at an intersection, another vehicle may aggressively cut into the destination lane, making the lane change unsafe. The planning stack 116 could have already determined an alternative plan for such an event, and upon its occurrence, help to direct the AV 102 to go around the block instead of blocking a current lane while waiting for an opening to change lanes.

The control stack 118 can manage the operation of the vehicle propulsion system 130, the braking system 132, the steering system 134, the safety system 136, and the cabin system 138. The control stack 118 can receive sensor signals from the sensor systems 104-108 as well as communicate with other stacks or components of the local computing device 110 or a remote system (e.g., the data center 150) to effectuate operation of the AV 102. For example, the control stack 118 can implement the final path or actions from the multiple paths or actions provided by the planning stack 116. This can involve turning the routes and decisions from the planning stack 116 into commands for the actuators that control the AV's steering, throttle, brake, and drive unit.

The communication stack 120 can transmit and receive signals between the various stacks and other components of the AV 102 and between the AV 102, the data center 150, the client computing device 170, and other remote systems. The communication stack 120 can enable the local computing device 110 to exchange information remotely over a network, such as through an antenna array or interface that can provide a metropolitan WI-FI® network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communication stack 120 can also facilitate local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 122 can store HD maps and related data of the streets upon which the AV 102 travels. In some embodiments, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane or road centerline, lane boundaries, type of lane boundaries, etc.) and related attributes (e.g., direction of travel, speed limit, lane type, etc.). The lanes and boundaries layer can also include 3D attributes related to lanes (e.g., slope, elevation, curvature, etc.). The intersections layer can include geospatial information of intersections (e.g., crosswalks, stop lines, turning lane centerlines, and/or boundaries, etc.) and related attributes (e.g., permissive, protected/permissive, or protected only left turn lanes; permissive, protected/permissive, or protected only U-turn lanes; permissive or protected only right turn lanes; etc.). The traffic controls layer can include geospatial information of traffic signal lights, traffic signs, and other road objects and related attributes.

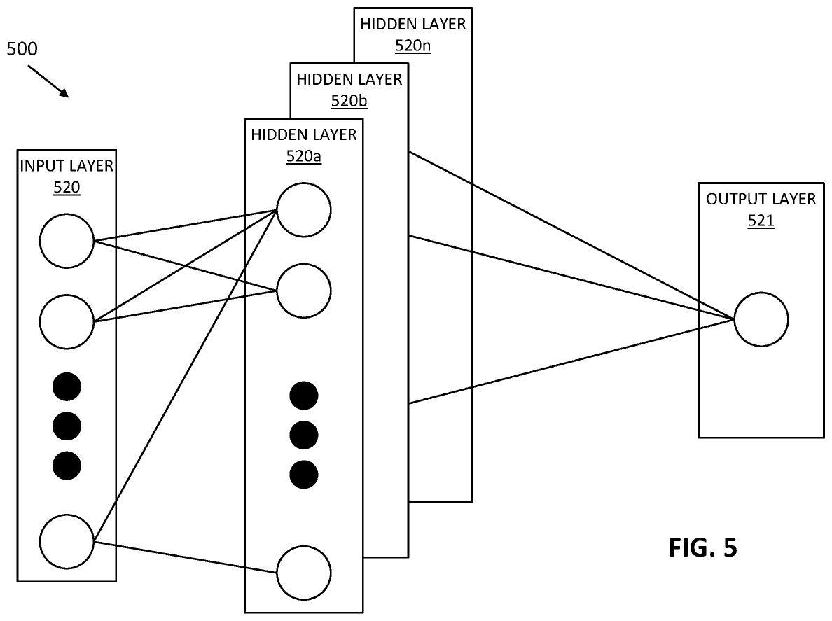

The AV operational database 124 can store raw AV data generated by the sensor systems 104-108 and other components of the AV 102 and/or data received by the AV 102 from remote systems (e.g., the data center 150, the client computing device 170, etc.). In some embodiments, the raw AV data can include HD LIDAR point cloud data, image or video data, RADAR data, GPS data, and other sensor data that the data center 150 can use for creating or updating AV geospatial data as discussed further below with respect to FIG. 5 and elsewhere in the present disclosure.

The data center 150 can be a private cloud (e.g., an enterprise network, a co-location provider network, etc.), a public cloud (e.g., an IaaS network, a PaaS network, a SaaS network, or other CSP network), a hybrid cloud, a multi-cloud, and so forth. The data center 150 can include one or more computing devices remote to the local computing device 110 for managing a fleet of AVs and AV-related services. For example, in addition to managing the AV 102, the data center 150 may also support a ridesharing service, a delivery service, a remote/roadside assistance service, street services (e.g., street mapping, street patrol, street cleaning, street metering, parking reservation, etc.), and the like.

The data center 150 can send and receive various signals to and from the AV 102 and the client computing device 170. These signals can include sensor data captured by the sensor systems 104-108, roadside assistance requests, software updates, ridesharing pick-up and drop-off instructions, and so forth. In this example, the data center 150 includes one or more of a data management platform 152, an Artificial Intelligence/Machine Learning (AI/ML) platform 154, a simulation platform 156, a remote assistance platform 158, a ridesharing platform 160, and a map management platform 162, among other systems.

Data management platform 152 can be a big data system capable of receiving and transmitting data at high speeds (e.g., near real-time or real-time), processing a large variety of data, and storing large volumes of data (e.g., terabytes, petabytes, or more of data). The varieties of data can include data having different structures (e.g., structured, semi-structured, unstructured, etc.), data of different types (e.g., sensor data, mechanical system data, ridesharing service data, map data, audio data, video data, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 150 can access data stored by the data management platform 152 to provide their respective services.

The AI/ML platform 154 can provide the infrastructure for training and evaluating machine learning algorithms for operating the AV 102, the simulation platform 156, the remote assistance platform 158, the ridesharing platform 160, the map management platform 162, and other platforms and systems. Using the AI/ML platform 154, data scientists can prepare data sets from the data management platform 152; select, design, and train machine learning models; evaluate, refine, and deploy the models; maintain, monitor, and retrain the models; and so on.

The simulation platform 156 can enable testing and validation of the algorithms, machine learning models, neural networks, and other development efforts for the AV 102, the remote assistance platform 158, the ridesharing platform 160, the map management platform 162, and other platforms and systems. The simulation platform 156 can replicate a variety of driving environments and/or reproduce real-world scenarios from data captured by the AV 102, including rendering geospatial information and road infrastructure (e.g., streets, lanes, crosswalks, traffic lights, stop signs, etc.) obtained from the map management platform 162; modeling the behavior of other vehicles, bicycles, pedestrians, and other dynamic elements; simulating inclement weather conditions, different traffic scenarios; and so on.

The remote assistance platform 158 can generate and transmit instructions regarding the operation of the AV 102. For example, in response to an output of the AI/ML platform 154 or other system of the data center 150, the remote assistance platform 158 can prepare instructions for one or more stacks or other components of the AV 102.

The ridesharing platform 160 can interact with a customer of a ridesharing service via a ridesharing application 172 executing on the client computing device 170. The client computing device 170 can be any type of computing system, including a server, desktop computer, laptop, tablet, smartphone, smart wearable device (e.g., smart watch; smart eyeglasses or other Head-Mounted Display (HMD); smart ear pods or other smart in-ear, on-ear, or over-ear device; etc.), gaming system, or other general purpose computing device for accessing the ridesharing application 172. The client computing device 170 can be a customer's mobile computing device or a computing device integrated with the AV 102 (e.g., the local computing device 110). The ridesharing platform 160 can receive requests to be picked up or dropped off from the ridesharing application 172 and dispatch the AV 102 for the trip.

Map management platform 162 can provide a set of tools for the manipulation and management of geographic and spatial (geospatial) and related attribute data. The data management platform 152 can receive LIDAR point cloud data, image data (e.g., still image, video, etc.), RADAR data, GPS data, and other sensor data (e.g., raw data) from one or more AVs 102, Unmanned Aerial Vehicles (UAVs), satellites, third-party mapping services, and other sources of geospatially referenced data. The raw data can be processed, and map management platform 162 can render base representations (e.g., tiles (2D), bounding volumes (3D), etc.) of the AV geospatial data to enable users to view, query, label, edit, and otherwise interact with the data. Map management platform 162 can manage workflows and tasks for operating on the AV geospatial data. Map management platform 162 can control access to the AV geospatial data, including granting or limiting access to the AV geospatial data based on user-based, role-based, group-based, task-based, and other attribute-based access control mechanisms. Map management platform 162 can provide version control for the AV geospatial data, such as to track specific changes that (human or machine) map editors have made to the data and to revert changes when necessary. Map management platform 162 can administer release management of the AV geospatial data, including distributing suitable iterations of the data to different users, computing devices, AVs, and other consumers of HD maps. Map management platform 162 can provide analytics regarding the AV geospatial data and related data, such as to generate insights relating to the throughput and quality of mapping tasks.

In some embodiments, the map viewing services of map management platform 162 can be modularized and deployed as part of one or more of the platforms and systems of the data center 150. For example, the AI/ML platform 154 may incorporate the map viewing services for visualizing the effectiveness of various object detection or object classification models, the simulation platform 156 may incorporate the map viewing services for recreating and visualizing certain driving scenarios, the remote assistance platform 158 may incorporate the map viewing services for replaying traffic incidents to facilitate and coordinate aid, the ridesharing platform 160 may incorporate the map viewing services into the client application 172 to enable passengers to view the AV 102 in transit en route to a pick-up or drop-off location, and so on.

Example Methods for Live Remote Assistance Request and Response Session

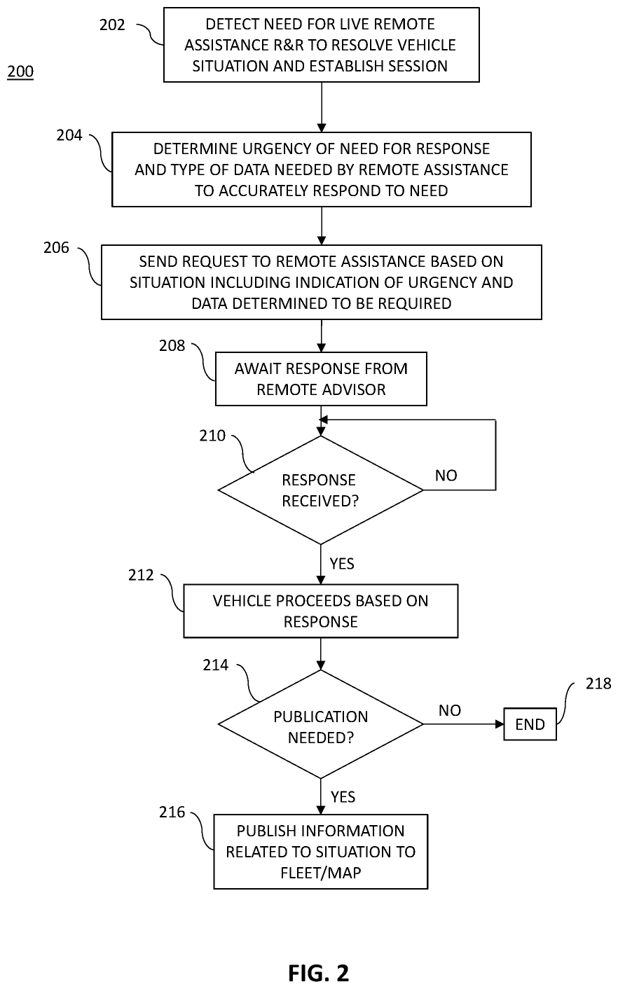

FIGS. 2-4 are flowcharts illustrating example processes for a live remote assistance request and response session for an AV rideshare service according to some embodiments of the present disclosure. In certain embodiments, one or more of the operations illustrated in FIGS. 2-4 may be executed by one or more of the elements shown in FIG. 1.

FIG. 2 illustrates a generalized example method 200 for a live remote assistance R&R session for an AV in accordance with one embodiment.

In operation 202, a need for a live remote assistance R&R session is detected by the AV and a session is established. Establishment of a live remote assistance R&R session may be triggered by a variety of issues. For example, one set of issues may be referred to as classification issues, which may be characterized by a difficulty or an inability of the perception system of the AV to characterize one or more objects to an acceptable level of confidence (e.g., a confidence value of the characterization is below a minimum threshold value). Another set of issues may be referred to as detection confirmation issues, which may be characterized by a need for detection of the existence of an unexpected object or the absence of an expected object to be confirmed and dealt with by a human observer/operator. Yet another set of issues may involve selection and/or execution of maneuvers to be performed by the AV given a set of circumstances in which the AV may find itself. Still another set of issues may be deemed troubleshooting issues, in which situations such as an AV door being open or the lens of an AV camera being dirty need to be dealt with by a human observer/operator. It should be noted that in some cases, the remote assistance could be a higher level/degree of computing power.

In operation 204, the urgency of the need for a live remote assistance R&R session, which may be dictated by an SLA-specified time constraint between a request and a response to the request in connection with the need, as well as the type of sensor data (e.g., video, still images, audio, etc.) needed by a remote advisor to accurately determine a solution and respond to the need, are determined based on a classification of the need or situation. For example, if the need involves confirmation of a map change, the SLA-specified time constraint may be in the range of approximately 30-60 seconds, for example, whereas if the need involves confirmation of a DPV or determination of the state of a traffic light, which may be a more urgent or immediate need, the SLA-specified time constraint may be in the range of approximately 5-10 seconds, for example. Determining whether a collision has occurred may have an even longer SLA-specified time constraint (e.g., 1-3 minutes). Additionally, determination of whether an object or blockage is a DPV may require real-time video data from a front camera of the AV, whereas confirmation of whether a noise is an emergency medical vehicle (EMV) siren may require audio data obtained by microphones of the AV.

In operation 206, a request is sent to the remote assistance platform regarding the need in accordance with the urgency of the request. The request will include the type of data (e.g., audio, video, still image) determined to be needed by the remote advisor depending on the issue, as well as the urgency of the need (e.g., high, medium, or low). For example, a high urgency need may be one with an SLA of less than approximately 10 seconds, a medium urgency need may be one with an SLA in the range of approximately 10-60 seconds, and a low urgency need may be one with an SLA of greater than one minute.

In operation 208, the AV awaits a response from the remote assistance platform to the request. In certain embodiments, this operation may include a remote advisor requesting additional/supplemental data from the AV to enable the remote advisor to make an accurate assessment of the situation. In particular embodiments, there may be a variety of requested responses; for example, (1) a final or actionable response, which allows the AV to move, shut down, take some sort of action, etc., and (2) a response to a request for information, which may provide information to the AV for use in making other determinations.

In operation 210, a determination is made whether a response has been received by the AV. If not, execution remains at operation 210 until a response is received by the AV and then proceeds to operation 212. Additionally and/or alternatively, if a predetermined period of time elapses without a response being received, the AV may simply proceed without remote assistance input.

In operation 212, the AV proceeds based on the response received from the remote assistance platform as determined by the remote advisor. The response from the remote advisor may provide information to the AV that may be used by the AV to update its state and/or to determine a particular action to take based on the response. For example, if the AV request to the remote advisor is whether EMV sirens can be heard, possible responses may include: (1) yes there are EMV sirens but there is no need to act immediately; (2) yes there are EMV sirens and a particular action is suggested to be taken (e.g., pull over); and (3) no there are no EMV sirens. Similarly, if the AV request to the remote advisor is whether an object is a DPV, possible responses may include yes or no. In certain embodiments, the RA response includes information that is fed into the planning stack for use by the AV in making a decision based on the response as well as other sources of input/information/sensor and other data available to the AV at the time.

In operation 214, a determination is made whether publication of the information is needed. For example, in cases in which construction is confirmed in a particular area, the information is published to the fleet so that other AVs in the fleet may be appropriately routed away from the area. Similarly, in cases in which a DPV is confirmed, the information may also be published to the fleet for similar reasons. Still further, if a map change is confirmed, the map information may be updated in accordance with the change. In contrast, certain types of information (e.g., confirmation of detection of an EMV siren) need not be published to the fleet. If it is determined that publication of the information is needed, execution proceeds to operation 216. In certain embodiments, the decision whether or not to publish may be based on a relative transience of the situation or issue. For example, a transient issue may be one that the AV and/or RA does not believe will last more than a threshold time period (e.g., 1-1000 seconds) or issues that have only been reported a threshold number of times, possibly during a specified time period (e.g., the issue was reported only once and therefore is likely to have been corrected before being encountered again). In these embodiments, transient issues are not published, whereas non-transient issues are published.

In operation 216, the information is published to the fleet. In certain embodiments, the information may be used to train and/or update classification and/or other algorithms employed by the local computing device of the AV, as well as by the data center 150.

If in operation 214 it is determined that publication is not needed, execution terminates in operation 218.

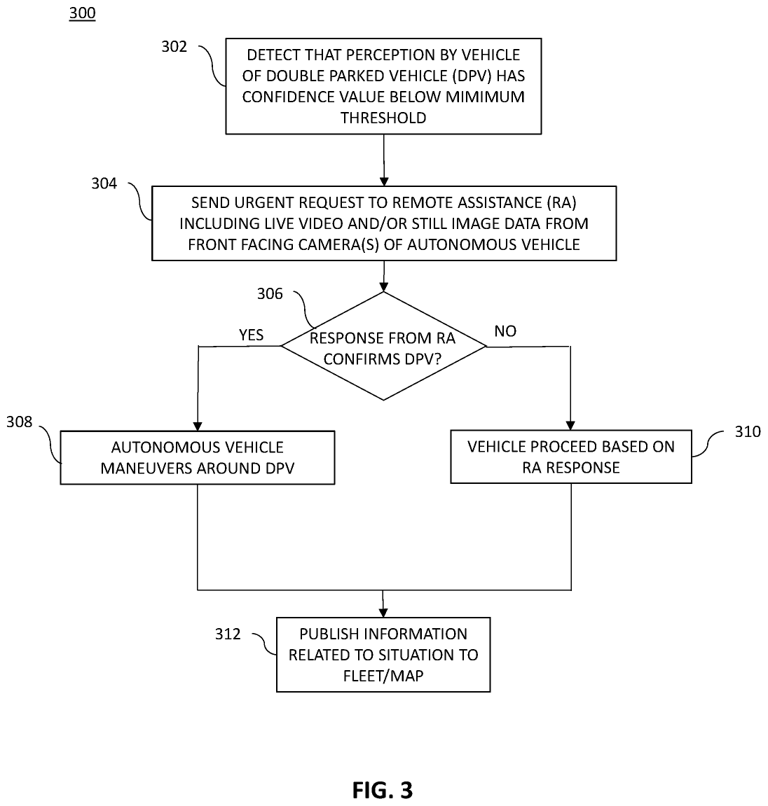

FIG. 3 illustrates an example method 300 for a particular application of a live remote assistance R&R session for an AV in accordance with one embodiment. In particular, the method 300 is a method for a live remote assistance R&R session for confirming whether an obstruction perceived by the AV is a DPV.

In operation 302, the AV's perception that an obstruction is a DPV has a confidence value less than a minimum threshold (e.g., 30%-80%). In other words, based on one or more sensor inputs (e.g., images, video, RADAR data, and LIDAR data) that have been processed by one or more components of a computing device of the AV (e.g., the perception stack 112) the AV is unable to determine with an appropriate level of confidence whether or not the obstruction is a DPV.

In operation 304, the AV sends an urgent request to the remote assistance platform, including live video data and/or still image data from one or more front facing cameras of the AV, LIDAR data and/or RADAR data.

In operation 306, after a response is received from the remote advisor at the remote assistance platform, a determination is made whether the response confirms that the obstruction is a DPV. If the response confirms that the obstruction is a DPV, execution proceeds to operation 308; otherwise, execution proceeds to operation 310. It will be noted that, if the response confirms that the obstruction is not a DPV, the response may indicate the accurate classification of the obstruction.

In operation 308, the AV maneuvers around the DPV as provided by the planning stack. For example, the AV may receive an indication from the remote advisor platform that the obstruction perceived by the AV is a DPV. The AV will feed this indication of the DPV into a software stack that is used by the AV to plan and maneuver the AV in its environment. In some embodiments, the response from the remote advisor platform may not only indicate that the obstruction is a DPV but also other characteristics of the DPV/obstructions. For example, the other characteristics may include one or more of (1) the type of vehicle (e.g., car, bus, EMV, etc.), (2) the size and/or length of the vehicle or set of vehicles that are DPVs, (3) the number of vehicles that are currently DPVs, (4) the orientation of the multiple DPVs (e.g., the multiple DPVs are stacked to take up multiple lanes of the roadway or are stacked in a single lane of the roadway), (5) whether doors of the vehicle are open, and (6) whether pedestrians or other objects are next to the vehicle.

In operation 310, the AV proceeds based on the response from the remote assistance platform (e.g., based on the classification of the obstruction as not a DPV). For example, if the obstruction is a construction dumpster or another obstruction that is semi-permanent, the planning stack may process the response in a manner that causes the AV to proceed around the obstruction. In contrast, if the obstruction is merely a vehicle stopped at an intersection, the planning stack may process the response in a manner that causes the AV to wait for the vehicle to proceed before proceeding itself.

In operation 312, the information related to the obstruction may be published to the fleet. It will be recognized that publication may be dependent on whether the obstruction is a DPV. For example, if the obstruction is determined to be a temporary non-DPV obstruction, there is no need to publish the information to the fleet. In contrast, if the vehicle is a DPV obstruction, such lane health information would be useful to the fleet and therefore published. It will be noted that in alternative embodiments, the information related to the obstruction may be published to the fleet regardless of whether it is determined to be a DPV.

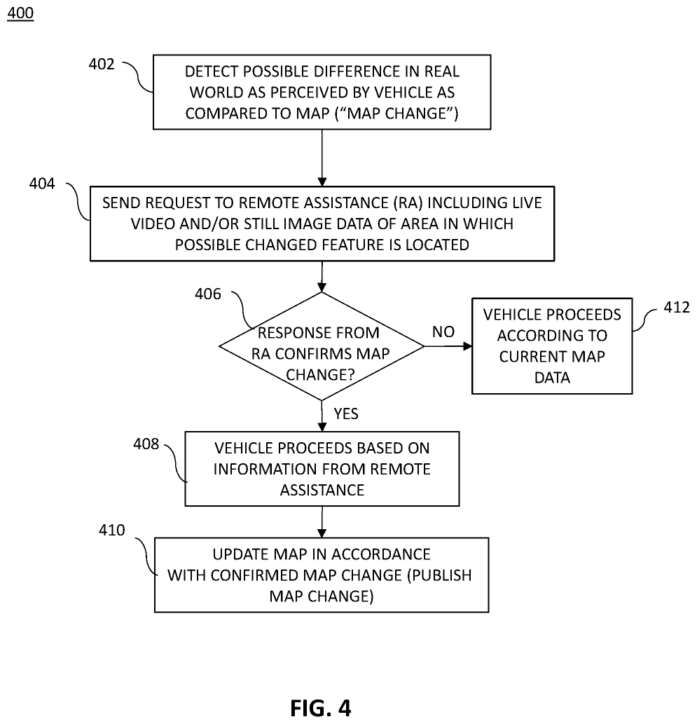

FIG. 4 illustrates another example method 400 for a particular application of a live remote assistance R&R session for an AV in accordance with one embodiment. In particular, the method 400 is a method for a live remote assistance R&R session for confirming whether a map change perceived by the AV has occurred.

In operation 402, a possible difference between the AV's perception of its real-world environment and a corresponding portion of the map is detected. In other words, a possible map change is detected by the AV. In many instances, map changes are the result of the reality that features in the real world change and maps become out of date. This reality causes a variety of issues that may require a human operator or other RA to process and manage. Map changes may include possible detection of an object in the AV's environment that is not included in the map and/or possible lack of detection of an object in AV's environment that is included in the map.

In operation 404, the AV sends a request to the remote assistance platform (e.g., “is there supposed to be a stop sign at this intersection as indicated in the map?) including live video data and/or still image data, as well as LIDAR and/or RADAR data, of the area obtained using one or more sensors of the AV, and an urgency level (e.g., high, medium, low, as described above) of the request. In some instances, the request may be an urgent request, such as in a case where an expected traffic light is missing and the AV must determine in real-time whether it is safe to proceed. In other instances, the request may be a non-urgent request, such as in a case where whether or not a map change has occurred does not impact route planning or safety of the AV and is reported only as a means to determine whether to update the fleet map data. Examples of non-urgent requests may include the absence of a street that was not part of the path that the AV was using or considering and/or the absence of a crosswalk that is not in the path of the AV.

In operation 406, after a response is received from the remote advisor at the remote assistance platform, a determination is made whether the response confirms that a map change has occurred. For example, the response may include an image with a bounding box around an object of interest and a label on the object to indicate the identity of the object (e.g., a stop sign). If the response confirms that a map change has occurred (i.e., there is a difference between the real-world environment of the AV and the map version of the environment), execution proceeds to operation 408; otherwise, execution proceeds to operation 412.

In operation 408, the AV proceeds based on the response from the remote assistance platform (e.g., based on the updated map information). For example, in a situation in which the RA confirms that the AV is approaching a crosswalk that is not indicated in the map, the AV will react appropriately at the crosswalk (e.g., stop and wait until the crosswalk is clear of pedestrians) rather than proceed without stopping, as would be the case if the crosswalk had not been added. Alternatively, in a situation in which the RA confirms that a crosswalk indicated in the map no longer exists, the AV may proceed through the area without stopping.

In operation 410, the map information distributed to the fleet may be updated to reflect the confirmed map change. Continuing with the crosswalk examples noted above, the map may be updated to include the crosswalk (in the first example) or remove the crosswalk (in the second example) so that other vehicles in the fleet may react and plan appropriately.

In operation 412, the vehicle proceeds according to the current map data, which has been confirmed to be accurate.

Although the operations of the example methods shown in FIGS. 2-4 are illustrated as occurring once each and in a particular order, it will be recognized that the operations may be performed in any suitable order and repeated as desired. Additionally, one or more operations may be performed in parallel. Furthermore, the operations illustrated in FIGS. 2-4 may be combined or may include more or fewer details than described.

The following is a non-exhaustive list of situations, which may be determined and/or considered by the AV to be ambiguous situations, in which a live remote assistance R&R session might find particular utility:
confirming detection of construction/clearance of construction;
clearance of a previously tagged avoidance area;
determining whether an obstruction is a DPV;
determining whether a traffic signal is operational;
confirming detection of a school bus;
confirming detection of an active EMV;
confirming detection of an EMV siren;
confirming classification of an object as a human controlling traffic (HCT);
confirming detection of a map change;
confirming occurrence of a collision;
assistance in deciding whether to maneuver around a small blockage vs. rerouting;
assistance in selecting a location in which to pull over;
assistance in deciding whether to pass on the right;
assistance in determining whether an AV should move after being involved in a collision;
assistance in determining a safe pullover location after a collision;
confirming whether to proceed after cutting to close to an undrivable area;
clarifying instructions from an EMV;
identifying a gap for pulling into traffic;
interpreting HCT gestures;
confirming that an AV door is ajar and triggering door closure; and
confirming whether one or more sensors of the AV are operating properly.

Each of the situations, or classifications, above may have associated therewith one or more possible questions to be posed to the remote assistance operator (or remote advisor), answers to each of the one or more possible questions, timing expectations (e.g., in accordance with SLA requirements), data needs (e.g., video, still image and/or audio, as well as possibly LIDAR and/or RADAR data), and an indication of whether the response, one or more portions of the response and/or an effect of the response should be published to the fleet (e.g., to map data accessible by the fleet).

Example Deep Learning Neural Network

In FIG. 5, the disclosure now turns to a further discussion of models that can be used through the environments and techniques described herein. Specifically, FIG. 5 is an illustrative example of a deep learning neural network 500 that can be used to implement all or a portion of a perception module (or perception system) as discussed above. An input layer 520 can be configured to receive sensor data and/or data relating to an environment surrounding an AV. The neural network 500 includes multiple hidden layers 522a, 522b, through 522n. The hidden layers 522a, 522b, through 522n include n number of hidden layers, where n is an integer greater than or equal to one. The number of hidden layers can be made to include as many layers as needed for the given application. The neural network 500 further includes an output layer 521 that provides an output resulting from the processing performed by the hidden layers 522a, 522b, through 522n. In one illustrative example, the output layer 521 can provide estimated treatment parameters that can be used/ingested by a differential simulator to estimate a patient treatment outcome.

The neural network 500 is a multi-layer neural network of interconnected nodes. Each node can represent a piece of information. Information associated with the nodes is shared among the different layers and each layer retains information as information is processed. In some cases, the neural network 500 can include a feed-forward network, in which case there are no feedback connections where outputs of the network are fed back into itself. In some cases, the neural network 500 can include a recurrent neural network, which can have loops that allow information to be carried across nodes while reading in input.

Information can be exchanged between nodes through node-to-node interconnections between the various layers. Nodes of the input layer 520 can activate a set of nodes in the first hidden layer 522a. For example, as shown, each of the input nodes of the input layer 520 is connected to each of the nodes of the first hidden layer 522a. The nodes of the first hidden layer 522a can transform the information of each input node by applying activation functions to the input node information. The information derived from the transformation can then be passed to and can activate the nodes of the next hidden layer 522b, which can perform their own designated functions. Example functions include convolutional, up-sampling, data transformation, and/or any other suitable functions. The output of the hidden layer 522b can then activate nodes of the next hidden layer, and so on. The output of the last hidden layer 522n can activate one or more nodes of the output layer 521, at which an output is provided. In some cases, while nodes in the neural network 500 are shown as having multiple output lines, a node can have a single output and all lines shown as being output from a node represent the same output value.

In some cases, each node or interconnection between nodes can have a weight that is a set of parameters derived from the training of the neural network 500. Once the neural network 500 is trained, it can be referred to as a trained neural network, which can be used to classify one or more activities. For example, an interconnection between nodes can represent a piece of information learned about the interconnected nodes. The interconnection can have a tunable numeric weight that can be tuned (e.g., based on a training dataset), allowing the neural network 500 to be adaptive to inputs and able to learn as more and more data is processed.

The neural network 500 is pre-trained to process the features from the data in the input layer 520 using the different hidden layers 522a, 522b, through 522n in order to provide the output through the output layer 521.

In some cases, the neural network 500 can adjust the weights of the nodes using a training process called backpropagation. A backpropagation process can include a forward pass, a loss function, a backward pass, and a weight update. The forward pass, loss function, backward pass, and parameter/weight update is performed for one training iteration. The process can be repeated for a certain number of iterations for each set of training data until the neural network 500 is trained well enough so that the weights of the layers are accurately tuned.

To perform training, a loss function can be used to analyze error in the output. Any suitable loss function definition can be used, such as a Cross-Entropy loss. Another example of a loss function includes the mean squared error (MSE), defined as E_total=Σ(½(target−output)²). The loss can be set to be equal to the value of E_total.

The loss (or error) will be high for the initial training data since the actual values will be much different than the predicted output. The goal of training is to minimize the amount of loss so that the predicted output is the same as the training output. The neural network 500 can perform a backward pass by determining which inputs (weights) most contributed to the loss of the network and can adjust the weights so that the loss decreases and is eventually minimized.

The neural network 500 can include any suitable deep network. One example includes a Convolutional Neural Network (CNN), which includes an input layer and an output layer, with multiple hidden layers between the input and out layers. The hidden layers of a CNN include a series of convolutional, nonlinear, pooling (for downsampling), and fully connected layers. The neural network 500 can include any other deep network other than a CNN, such as an autoencoder, Deep Belief Nets (DBNs), Recurrent Neural Networks (RNNs), among others.

As understood by those of skill in the art, machine learning based classification techniques can vary depending on the desired implementation. For example, machine learning classification schemes can utilize one or more of the following, alone or in combination: hidden Markov models; RNNs; CNNs; deep learning; Bayesian symbolic methods; Generative Adversarial Networks (GANs); support vector machines; image registration methods; and applicable rule-based systems. Where regression algorithms are used, they may include but are not limited to a Stochastic Gradient Descent Regressor, a Passive Aggressive Regressor, etc.

Machine learning classification models can also be based on clustering algorithms (e.g., a Mini-batch K-means clustering algorithm), a recommendation algorithm (e.g., a Minwise Hashing algorithm, or Euclidean Locality-Sensitive Hashing (LSH) algorithm), and/or an anomaly detection algorithm, such as a local outlier factor. Additionally, machine learning models can employ a dimensionality reduction approach, such as, one or more of: a Mini-batch Dictionary Learning algorithm, an incremental Principal Component Analysis (PCA) algorithm, a Latent Dirichlet Allocation algorithm, and/or a Mini-batch K-means algorithm, etc.

Example Processor-Based System

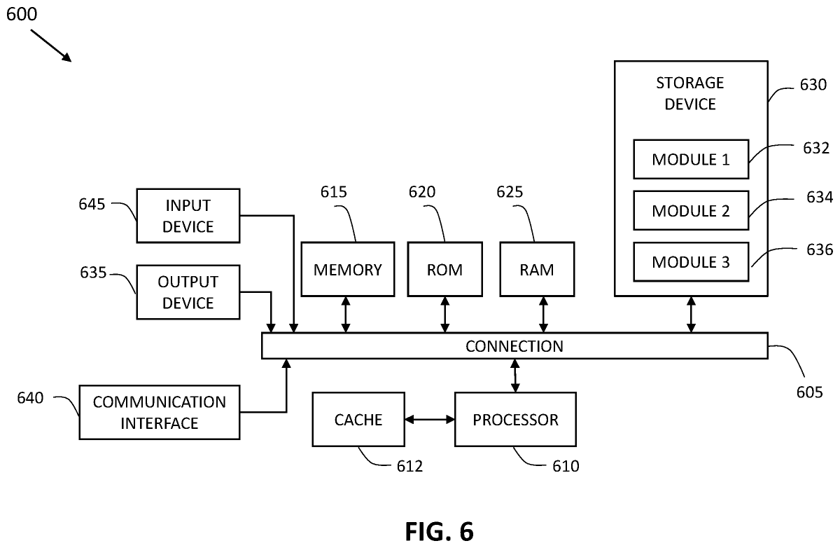

FIG. 6 illustrates an example processor-based system with which some aspects of the subject technology can be implemented. For example, processor-based system 600 can be any computing device making up, or any component thereof in which the components of the system are in communication with each other using connection 605. Connection 605 can be a physical connection via a bus, or a direct connection into processor 610, such as in a chipset architecture. Connection 605 can also be a virtual connection, networked connection, or logical connection.

In some embodiments, computing system 600 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 600 includes at least one processing unit (Central Processing Unit (CPU) or processor) 610 and connection 605 that couples various system components including system memory 615, such as Read-Only Memory (ROM) 620 and Random-Access Memory (RAM) 625 to processor 610. Computing system 600 can include a cache of high-speed memory 612 connected directly with, in close proximity to, or integrated as part of processor 610.

Processor 610 can include any general purpose processor and a hardware service or software service, such as services 632, 634, and 636 stored in storage device 630, configured to control processor 610 as well as a special purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction, computing system 600 includes an input device 645, which can represent any number of input mechanisms, such as a microphone for speech, a touch-sensitive screen for gesture or graphical input, keyboard, mouse, motion input, speech, etc. Computing system 600 can also include output device 635, which can be one or more of a number of output mechanisms known to those of skill in the art. In some instances, multimodal systems can enable a user to provide multiple types of input/output to communicate with computing system 600. Computing system 600 can include communications interface 640, which can generally govern and manage the user input and system output. The communication interface may perform or facilitate receipt and/or transmission wired or wireless communications via wired and/or wireless transceivers, including those making use of an audio jack/plug, a microphone jack/plug, a USB port/plug, an APPLE® LIGHTNING® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 WI-FI® wireless signal transfer, WLAN signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 640 may also include one or more GNSS receivers or transceivers that are used to determine a location of the computing system 600 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 630 can be a non-volatile and/or non-transitory and/or computer-readable memory device and can be a hard disk or other types of computer-readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid state memory, a Compact Disc Read-Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a MEMORY STICK® card, a smartcard chip, a EMV chip, a Subscriber Identity Module (SIM) card, a mini/micro/nano/pico SIM card, another Integrated Circuit (IC) chip/card, Random-Access Memory (RAM), Static RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L #), Resistive RAM (RRAM/ReRAM), Phase Change Memory (PCM), Spin Transfer Torque RAM (STT-RAM), another memory chip or cartridge, and/or a combination thereof.

Storage device 630 can include software services, servers, services, etc., that when the code that defines such software is executed by the processor 610, it causes the system 600 to perform a function. In some embodiments, a hardware service that performs a particular function can include the software component stored in a computer-readable medium in connection with the necessary hardware components, such as processor 610, connection 605, output device 635, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special purpose processors, etc. that perform tasks or implement abstract data types. Computer-executable instructions, associated data structures, and program modules represent examples of the program code means for executing operations of the methods disclosed herein. The particular sequence of such executable instructions or associated data structures represents examples of corresponding acts for implementing the functions described in such operations.

Other embodiments of the disclosure may be practiced in network computing environments with many types of computer system configurations, including personal computers, hand-held devices, multi-processor systems, microprocessor-based or programmable consumer electronics, network personal computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

### SELECTED EXAMPLES

Example 1 provides a method comprising detecting by a vehicle an ambiguous situation involving the vehicle; classifying the detected ambiguous situation; and submitting in substantially real-time a request for remote assistance by a remote advisor to resolve the detected ambiguous situation, wherein contents of the request are based at least in part on the classifying.

Example 2 provides the method of example 1, wherein contents of the request comprise sensor data.

Example 3 provides the method of example 2, wherein a type of the sensor data is based on the classifying.

Example 4 provides the method of any of examples 1-3, wherein the sensor data comprises at least one of video data, still image data, and audio data.

Example 5 provides the method of any of examples 1-4, wherein the submitting is performed with regard to a service level agreement (SLA) time constraint associated with a classification of the ambiguous situation.

Example 6 provides the method of any of examples 1-5, further comprising receiving a response to the request, wherein the response is based on an analysis of the contents of the request.

Example 7 provides the method of example 6, further comprising operating the vehicle in accordance with the response.

Example 8 provides the method of example 6, further comprising performing an action in connection with the vehicle in accordance with the response.

Example 9 provides the method of example 6, wherein the vehicle is a member of a fleet of vehicles, the method further comprising updating a fleet database based on the response.

Example 10 provides the method of any of examples 1-9, wherein the remote advisor comprises a human.

Example 11 provides the method of any of examples 1-10, wherein the vehicle comprises an autonomous vehicle.

Example 12 provides one or more non-transitory computer-readable storage media comprising instruction for execution which, when executed by a processor, are operable to perform operations for providing remote assistance to a vehicle, the operations comprising, subsequent to detection by a vehicle of a situation involving the vehicle and requiring input from a human advisor, assigning a classification to the detected situation and submitting in real-time a request to the human advisor, wherein the human advisor is remotely located from the vehicle and contents of the request are based at least in part on the classification; receiving a response to the request from the remotely located human advisor, wherein the request is based on an analysis of the contents of the request by the human advisor; and causing the vehicle to perform an action in accordance with the received response.

Example 13 provides the one or more non-transitory computer-readable storage media of example 12, wherein the contents of the request comprise sensor data from one or more onboard sensors of the vehicle.

Example 14 provides the one or more non-transitory computer-readable storage media of example 13, wherein the sensor data comprises at least one of video data, still image data, and audio data.

Example 15 provides the one or more non-transitory computer-readable storage media of any of examples 12-14, wherein the submitting is performed in accordance with a service level agreement (SLA) time constraint associated with the classification.

Example 16 provides the one or more non-transitory computer-readable storage media of any of examples 12-15, wherein the vehicle is a member of a fleet of vehicles, the method further comprising updating a fleet database based on the response.

Example 17 provides a system comprising a vehicle including at least one onboard sensor for generating sensor data representative of an environment of the vehicle; and a live remote assistance request and response (R&R) session module configured to subsequent to detection by the vehicle of a situation involving the vehicle and requiring input from a human advisor, assign a classification to the detected situation and submit in real-time a request to the human advisor, wherein the human advisor is remotely located from the vehicle and contents of the request are based at least in part on the classification; receive a response to the request from the remotely located human advisor, wherein the request is based on an analysis of the contents of the request by the human advisor; and cause the vehicle to perform an action in accordance with the received response, wherein the contents of the request comp\rise sensor data from one or more of the at least one onboard sensor.

Example 18 provides the system of example 17, wherein the sensor data comprises at least one of video data, still image data, and audio data.

Example 19 provides the system of any of examples 17-18, wherein the submitting is performed in accordance with a service level agreement (SLA) time constraint associated with the classification.

Example 20 provides the system of any of examples 17-19, wherein the vehicle is an autonomous vehicle (AV) comprising a member of a fleet of AVs, the live remote assistance R&R session module further configured to update a remote database accessible by the fleet based on the response.

Other Implementation Notes, Variations, and Applications

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

In one example embodiment, any number of electrical circuits of the figures may be implemented on a board of an associated electronic device. The board can be a general circuit board that can hold various components of the interior electronic system of the electronic device and, further, provide connectors for other peripherals. More specifically, the board can provide the electrical connections by which the other components of the system can communicate electrically. Any suitable processors (inclusive of digital signal processors, microprocessors, supporting chipsets, etc.), computer-readable non-transitory memory elements, etc. can be suitably coupled to the board based on particular configuration needs, processing demands, computer designs, etc. Other components such as exterior storage, additional sensors, controllers for audio/video display, and peripheral devices may be attached to the board as plug-in cards, via cables, or integrated into the board itself. In various embodiments, the functionalities described herein may be implemented in emulation form as software or firmware running within one or more configurable (e.g., programmable) elements arranged in a structure that supports these functions. The software or firmware providing the emulation may be provided on non-transitory computer-readable storage medium comprising instructions to allow a processor to carry out those functionalities.

It is also imperative to note that all of the specifications, dimensions, and relationships outlined herein (e.g., the number of processors, logic operations, etc.) have only been offered for purposes of example and teaching only. Such information may be varied considerably without departing from the spirit of the present disclosure, or the scope of the appended examples. The specifications apply only to one non-limiting example and, accordingly, they should be construed as such. In the foregoing description, example embodiments have been described with reference to particular arrangements of components. Various modifications and changes may be made to such embodiments without departing from the scope of the appended examples. The description and drawings are, accordingly, to be regarded in an illustrative rather than in a restrictive sense.

Note that with the numerous examples provided herein, interaction may be described in terms of two, three, four, or more components; however, this has been done for purposes of clarity and example only. It should be appreciated that the system can be consolidated in any suitable manner. Along similar design alternatives, any of the illustrated components, modules, and elements of the FIGS. may be combined in various possible configurations, all of which are clearly within the broad scope of this Specification.

Various operations may be described as multiple discrete actions or operations in turn in a manner that is most helpful in understanding the example subject matter. However, the order of description should not be construed as to imply that these operations are necessarily order dependent. In particular, these operations may not be performed in the order of presentation. Operations described may be performed in a different order from the described embodiment. Various additional operations may be performed, and/or described operations may be omitted in additional embodiments.

Note that in this Specification, references to various features (e.g., elements, structures, modules, components, steps, operations, characteristics, etc.) included in one embodiment, example embodiment, an embodiment, another embodiment, some embodiments, various embodiments, other embodiments, alternative embodiment, and the like are intended to mean that any such features are included in one or more embodiments of the present disclosure, but may or may not necessarily be combined in the same embodiments.

Numerous other changes, substitutions, variations, alterations, and modifications may be ascertained to one skilled in the art and it is intended that the present disclosure encompass all such changes, substitutions, variations, alterations, and modifications as falling within the scope of the appended examples. Note that all optional features of the systems and methods described above may also be implemented with respect to the methods or systems described herein and specifics in the examples may be used anywhere in one or more embodiments.

In order to assist the United States Patent and Trademark Office (USPTO) and, additionally, any readers of any patent issued on this application in interpreting the examples appended hereto, Applicant wishes to note that the Applicant: (a) does not intend any of the appended examples to invoke paragraph (f) of 35 U.S.C. Section 112 as it exists on the date of the filing hereof unless the words means for or step for are specifically used in the particular examples; and (b) does not intend, by any statement in the Specification, to limit this disclosure in any way that is not otherwise reflected in the appended examples.

What is claimed is:

1. A method comprising:
detecting by a vehicle an ambiguous situation involving the vehicle maneuvering through an environment;
classifying the detected ambiguous situation from a set of ambiguous situations; and
submitting in substantially real-time a request for remote assistance by a remote advisor to resolve the detected ambiguous situation, wherein contents of the request are based at least in part on the classifying.

2. The method of claim 1, wherein contents of the request comprise sensor data and an urgency associated with the ambiguous situation.

3. The method of claim 2, wherein a type of the sensor data is based on the classifying.

4. The method of claim 1, wherein the sensor data comprises at least one of video data, still image data, and audio data.

5. The method of claim 1, wherein the submitting is performed with regard to a service level agreement (SLA) time constraint associated with a classification of the ambiguous situation.

6. The method of claim 1, further comprising receiving a response to the request, wherein the response is based on an analysis of the contents of the request.

7. The method of claim 6, further comprising operating the vehicle in accordance with the response.

8. The method of claim 6, further comprising performing an action in connection with the vehicle in accordance with the response.

9. The method of claim 6, wherein the vehicle is a member of a fleet of vehicles, the method further comprising updating a fleet database based on the response.

10. The method of claim 1, wherein the remote advisor comprises a human.

11. The method of claim 1, wherein the vehicle comprises an autonomous vehicle.

12. One or more non-transitory computer-readable storage media comprising instruction for execution which, when executed by a processor, are operable to perform operations for providing remote assistance to a vehicle, the operations comprising:
subsequent to detection by a vehicle of a situation involving the vehicle and requiring input from a human advisor:
assigning a classification to the detected situation; and
submitting in real-time a request to the human advisor, wherein the human advisor is remotely located from the vehicle and contents of the request are based at least in part on the classification;
receiving a response to the request from the remotely located human advisor, wherein the request is based on an analysis of the contents of the request by the human advisor; and
causing the vehicle to perform an action in accordance with the received response.

13. The one or more non-transitory computer-readable storage media of claim 12, wherein the contents of the request comprise sensor data from one or more onboard sensors of the vehicle.

14. The one or more non-transitory computer-readable storage media of claim 13, wherein the sensor data comprises at least one of video data, still image data, and audio data.

15. The one or more non-transitory computer-readable storage media of claim 12, wherein the submitting is performed in accordance with a service level agreement (SLA) time constraint associated with the classification.

16. The one or more non-transitory computer-readable storage media of claim 12, wherein the vehicle is a member of a fleet of vehicles, the operations further comprising updating a fleet database based on the response.

17. A system comprising:
a vehicle comprising at least one onboard sensor for generating sensor data representative of an environment of the vehicle; and
a live remote assistance request and response (R&R) session module configured to:
subsequent to detection by the vehicle of a situation involving the vehicle and requiring input from a human advisor, assign a classification to the detected situation and submit in real-time a request to the human advisor, wherein the human advisor is remotely located from the vehicle and contents of the request are based at least in part on the classification;
receive a response to the request from the remotely located human advisor, wherein the request is based on an analysis of the contents of the request by the human advisor; and
cause the vehicle to perform an action in accordance with the received response,
wherein the contents of the request comprise sensor data from one or more of the at least one onboard sensor.

18. The system of claim 17, wherein the sensor data comprises at least one of video data, still image data, and audio data.

19. The system of claim 17, wherein the submitting is performed in accordance with a service level agreement (SLA) time constraint associated with the classification.

20. The system of claim 17, wherein the vehicle is an autonomous vehicle (AV) comprising a member of a fleet of AVs, the live remote assistance R&R session module further configured to update a remote database accessible by the fleet based on the response.
